(19) United States
(12) Patent Application Publication
(10) Pub. No.: US 2026/0049726 A1
(43) Pub. Date: Feb. 19, 2026

(54) AIR CONDITIONING MASS TRANSFER ASSEMBLIES WITH DIRECTED LIQUID DESICCANT FLOW

(71) Applicant: BLUE FRONTIER INC., Boca Raton, FL (US)

(72) Inventors: Matthew TILGHMAN, Pennington, NJ (US); Daniel A. BETTS, Parkland, FL (US); Matthew GRAHAM, West Palm Beach, FL (US); Dmitry LUZHANSKY, Hallandale Beach, FL (US); Chuanfang Theodore YANG, Coconut Creek, FL (US); Chase CAMAROTTI, Oakland Park, FL (US)

(73) Assignee: BLUE FRONTIER INC., Boca Raton, FL (US)

(21) Appl. No.: 19/300,741

(22) Filed: Aug. 15, 2025

Related U.S. Application Data
(60) Provisional application No. 63/684,147, filed on Aug. 16, 2024.

(51) Int. Cl. F24F 3/14; B01D 53/26; F24F 3/147

(52) U.S. Cl. CPC F24F 3/1417; B01D 53/263; F24F 3/147; B01D 2257/80; B01D 2259/4508; F24F 2003/1435; F24F 2003/144

(57) ABSTRACT

The disclosure relates to mass transfer assemblies for heating ventilation and cooling systems.

### CROSS-REFERENCE TO RELATED APPLICATIONS

This application claims priority under 35 U.S.C. § 119(e) to U.S. Provisional Application No. 63/684,147, filed on Aug. 16, 2024, the entire contents of which are incorporated herein by reference.

### TECHNICAL FIELD

The disclosure relates generally to heating ventilation and cooling systems and, more particularly, to mass transfer assemblies for heating ventilation and cooling systems.

### BACKGROUND

Heating ventilation and cooling (HVAC) systems generally cool ambient or room temperature air using a vapor compression refrigeration cycle. For example, a conditioner of the HVAC systems may blow a stream of air across plates or coils that flow a refrigerant within, thereby removing heat from the stream of air. These HVAC systems may also include a heat exchanger that operates to remove heat from the refrigerant. For example, the heat exchanger may include additional plates or coils through which the refrigerant flows. A fan may blow air across the additional plates or coils to cool the refrigerant flowing within. In some HVAC systems, such as liquid desiccant air conditioning (LDAC) systems, the heat exchangers may include a liquid desiccant to dehumidify the air during the cooling process.

### SUMMARY

In some embodiments, a plate assembly is provided that includes a first plate having a first side defining a side of a conditioning channel, and a second side, opposite the first side, defining a side of an exhaust channel; and wicking material adjacent the first side of the first plate, the wicking material comprising a surface comprising a plurality of surface features.

In some embodiments, the first plate is configured to provide liquid desiccant to the wicking material.

In some embodiments, the plurality of surface features alter a flow of the liquid desiccant along the surface of the wicking material.

In some embodiments, the plurality of surface features comprise cutouts in the surface of the wicking material.

In some embodiments, the plurality of surface features comprise embossed features.

In some embodiments, the embossed features comprise at least one feature that is stamped, molded, machined, 3D printed, or additively attached to the wicking material.

In some embodiments, the plurality of surface features are hydrophilic.

In some embodiments, the plurality of surface features comprise a second wicking material coupled to the wicking material and provides topography to the surface of the wicking material.

In some embodiments, the wicking material and the second wicking material are made from a same material.

In some embodiments, the wicking material and the second wicking material are made from a same material.

In some embodiments, the plurality of surface features comprise protrusions that extend into the conditioning channel.

In some embodiments, the plurality of surface features are configured to disperse or redirect surface flow of the liquid desiccant as they flow along the surface of the wicking material.

In some embodiments, the plurality of surface features are configured to disperse the rivulets to provide more uniform wetting of the wicking material.

In some embodiments, the plurality of surface features form symmetric patterns along the surface of the wicking material.

In some embodiments, the plurality of surface features form asymmetric patterns along the surface of the wicking material.

In some embodiments, the plurality of surface features are uniformly distributed throughout a surface of the wicking material.

In some embodiments, a density of the plurality of surface features decreases in a downward direction along the surface of the wicking material.

In some embodiments, a density of the plurality of surface features increases in a downward direction along the surface of the wicking material.

In some embodiments, the surface comprising the plurality of surface features faces the conditioning channel.

In some embodiments, the surface comprising the plurality of surface features faces the conditioning channel, and the surface comprising the plurality of surface features faces the first plate.

In some embodiments, the plate assembly includes a second plate defining another side of the conditioning channel; and additional wicking material adjacent the second plate, the additional wicking material comprising a surface comprising additional surface features.

In some embodiments, the additional surface features are staggered with respect to the plurality of surface features across the conditioning channel.

In some embodiments, a first pattern of the plurality of surface features is different from a second pattern of the additional surface features.

In some embodiments, the additional surface features comprise protrusions that extend into the conditioning channel.

In some embodiments, the second plate is configured to provide additional liquid desiccant to the additional wicking material.

### BRIEF DESCRIPTION OF THE DRAWINGS

The following drawings are illustrative of particular embodiments of the present disclosure and therefore do not limit the scope of the present disclosure. The drawings are not to scale and are intended for use in conjunction with the explanations in the following detailed description.

FIG. 1 illustrates wicking material that includes surface features, in accordance with one embodiment;

FIG. 2 illustrates wicking material that includes surface features, in accordance with one embodiment;

FIG. 3 illustrates wicking material with surface features, in accordance with one embodiment;

FIG. 4A illustrates a mass transfer assembly that includes wicking material with surface features, in accordance with one embodiment;

FIG. 4B illustrates a mass transfer assembly that includes wicking material with surface features, in accordance with one embodiment;

FIG. 5A, illustrates a mass transfer assembly that includes wicking material with surface features, in accordance with one embodiment;

FIG. 5B illustrates a mass transfer assembly that includes wicking material with surface features, in accordance with one embodiment; and

FIG. 6 illustrates a view of a mass transfer apparatus that includes wicking material, in accordance with one embodiment.

### DETAILED DESCRIPTION

The following discussion omits or only briefly describes conventional features of heat and mass exchangers that are apparent to those skilled in the art. It is noted that various embodiments are described in detail with reference to the drawings, in which like reference numerals represent like parts and assemblies throughout the several views. Reference to various embodiments does not limit the scope of the claims attached hereto. Additionally, any examples set forth in this specification are intended to be non-limiting and merely set forth some of the many possible embodiments for the appended claims. Further, particular features described herein can be used in combination with other described features in each of the various possible combinations and permutations.

Unless otherwise specifically defined herein, all terms are to be given their broadest reasonable interpretation including meanings implied from the specification as well as meanings understood by those skilled in the art and/or as defined in dictionaries, treatises, etc. It must also be noted that, as used in the specification and the appended claims, the singular forms “a,” “an” and “the” include plural referents unless otherwise specified, and that the terms “includes” and/or “including,” when used in this specification, specify the presence of stated features, elements, and/or components, but do not preclude the presence or addition of one or more other features, steps, operations, elements, components, and/or groups thereof. In the description, relative terms such as “horizontal,” “vertical,” “up,” “down,” “top,” and “bottom” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation. Terms including “above” versus “below,” “inwardly” versus “outwardly,” “longitudinal” versus “lateral,” and the like are to be interpreted relative to one another or relative to an axis of elongation, or an axis or center of rotation, as appropriate. Terms concerning attachments, coupling, and the like, such as “connected” and “interconnected,” refer to a relationship wherein structures are secured or attached to one another either directly or indirectly through intervening structures, as well as both movable or rigid attachments or relationships, unless expressly described otherwise. The terms “operatively connected,” “operably connected,” and the like are such attachments, couplings, or connections that allow the pertinent structures to operate as intended by virtue of that relationship.

Embodiments of the present disclosure relate generally to heating, ventilation, and cooling (HVAC) systems and, more particularly, to mass transfer assemblies that direct the flow of a fluid stream, such as an air stream, through multiple channels to transfer heat from the fluid stream and/or dehumidify the fluid stream. For example, the mass transfer assemblies may include a stack of plates that define a plurality of channel pairs where each channel pair has one conditioning channel and one exhaust channel. The mass transfer assemblies may be adapted to feed the fluid stream to the conditioning channels to be conditioned, and feed at least a portion of the conditioned fluid feed stream to the exhaust channels. At least some of the conditioning channels may include wicking material with surface features as described herein. The mass transfer assemblies may provide liquid desiccant to the wicking material. As the liquid desiccant travels through or along the wicking material, the surface features direct the flow of the liquid desiccant to other (e.g., less wetted) portions of the wicking material. As the fluid flow proceeds through these conditioning channels, the fluid flow is dehumidified by the liquid desiccant.

In some examples, a plate assembly includes a plate with a first side defining a side of a conditioning channel, and a second side, opposite the first side, defining a side of an exhaust channel. The plate assembly also includes wicking material along the first side of the plate. The plate assembly may be configured to provide liquid desiccant to the wicking material. For example, the plate assembly may include a fluid distribution system that provides liquid desiccant to an upper portion of the wicking material, whereby gravity draws the liquid desiccant down through and along a surface of the wicking material. While the wicking material is designed for fluid to wick in the interstitial space, the rate of liquid desiccant fed into the wicking material may exceed the rate at which the liquid desiccant can flow within the wicking material. In such instances, a portion of the liquid desiccant will overflow the pores of the wicking material and flow along a surface of the wicking material. The surface features described herein are adapted to increase spreading of the liquid desiccant to at least portions of the entire wicking material and/or make the surface flow more uniform (e.g., approximating sheet flow) rather that concentrated in rivulets (e.g., high flow areas that resemble rivers).

Further, the surface of the wicking material can include a plurality of surface features. These surface features may include, for example, embossed features, cutouts, stamped features, molded features, machined features, 3D printed features, or additively attached features (e.g., features made of additional wicking material). The surface features may alter a flow of the liquid desiccant along the surface of the wicking material. The surface features may be made of various materials, such as the same or different wicking material, or any other suitable material. In some embodiments, the surface features are hydrophilic. In some examples, the surface features are hydrophobic.

In some examples, the surface features include protrusions that extend into the conditioning channel. In some examples, the surface features disperse or redirect surface flow (e.g., rivulets) of the liquid desiccant as the liquid desiccant flows along the surface of the wicking material. The surface features may be configured to disperse the surface flow to provide a more uniform wetting of the wicking material.

In some examples, the plurality of surface features form symmetric patterns along the surface of the wicking material. In some examples, the plurality of surface features form asymmetric patterns along the surface of the wicking material. In other examples, the plurality of surface features are uniformly distributed throughout a surface of the wicking material.

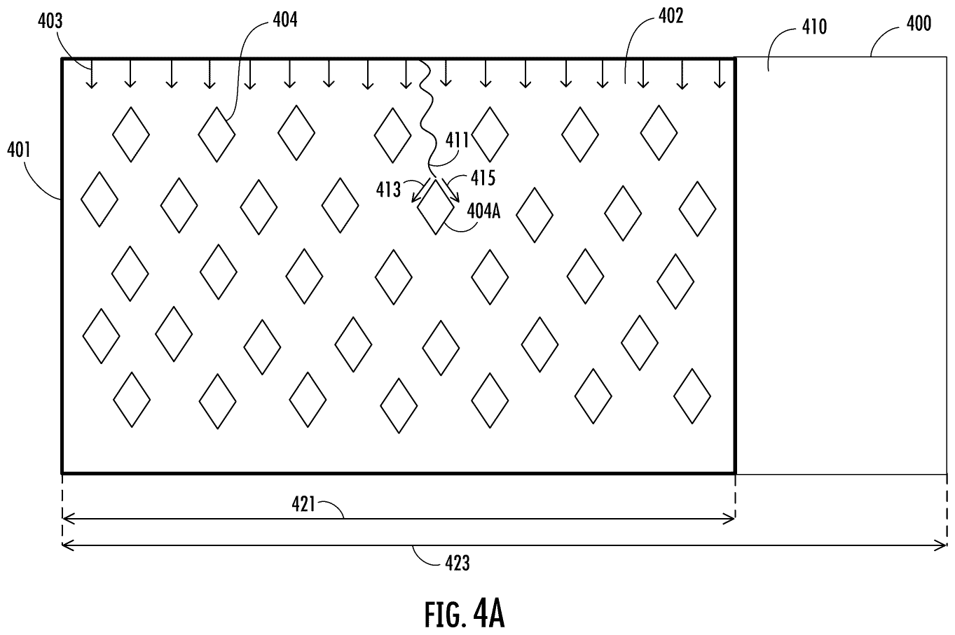

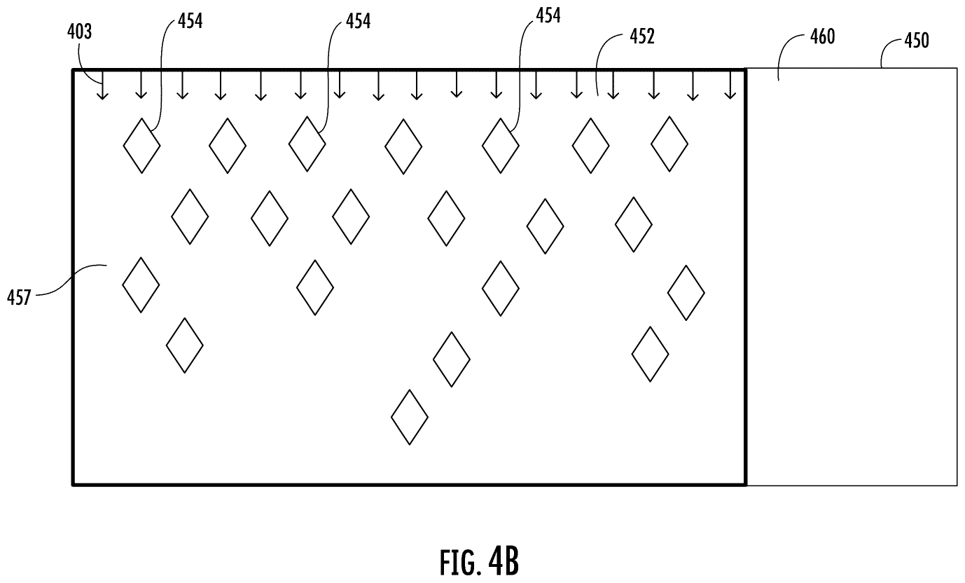

In some examples, as in FIG. 4B, a density of the plurality of surface features decreases in a downward direction along the surface of the wicking material. In yet other examples, the density of the plurality of surface features increases in the downward direction along the surface of the wicking material. The surface features may be porous, which can cause friction thereby slowing liquid desiccant sheet flow. In some examples, the porous surface features may cause the incorporation of at least some of the liquid desiccant into the wicking material.

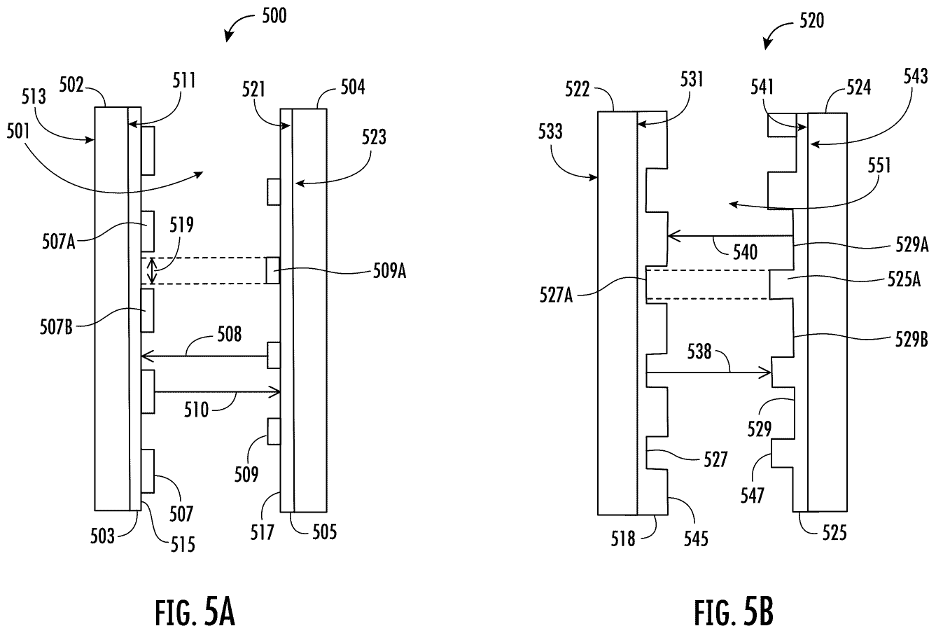

In some examples, as shown in FIGS. 5A and 5B, the plate assembly includes a second plate defining another side of the conditioning channel. The plate assembly also includes additional wicking material along the second plate. The additional wicking material has a surface with additional surface features. In some examples, as shown in FIGS. 5A and 5B, the additional surface features are staggered with respect to the surface features of the wicking material across the conditioning channel. In some examples, a first pattern of the surface features is different from a second pattern of the additional surface features.

Similar to the surface features of the wicking material, the additional surface features may be embossed features, cutouts, stamped features, molded features, machined features, 3D printed features, or additively attached features (e.g., features made of additional wicking material). The additional surface features may be made of various materials, such as the same or different wicking material, hydrophilic material, or any other suitable material.

The additional surface features can include protrusions that extend into the conditioning channel. In some examples, the additional surface features disperse or redirect surface flow (e.g., rivulets) of the liquid desiccant as the liquid desiccant flows along the surface of the additional wicking material. The additional surface features may be configured to disperse the surface flow to provide a more uniform wetting of the additional wicking material.

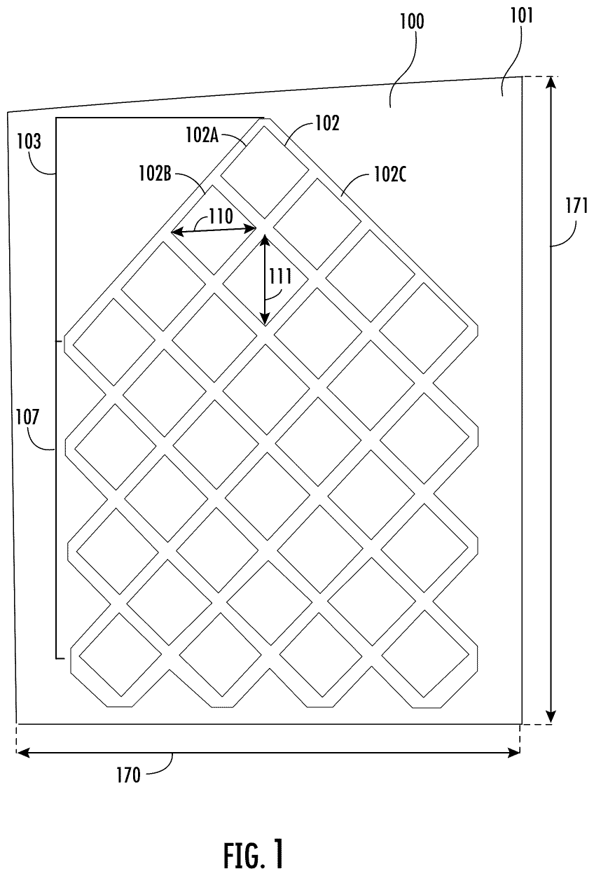

Referring to the drawings, FIG. 1 illustrates wicking material 100 that includes surface features 102. When liquid desiccant is provided to an upper edge of the wicking material 100, the surface features 102 may alter a flow of the liquid desiccant along a surface 101 of or within the wicking material 100. For instance, the surface features 102 may disperse or redirect surface flow of the liquid desiccant as it flows along the surface 101 of the wicking material 100. Among other advantages, the surface features 102 may redirect the liquid desiccant to unwetted, or less wet, areas of the wicking material 100, which may provide a more uniform wetting of the wicking material 100.

In this example, the surface features 102 are 3D printed onto the wicking material 100. As such, the surface features 102 may be made of a plastic, powder, resin, metal, carbon fiber, or any other material suitable for 3D printing. In some examples, the surface features 102 may be stamped, molded, machined, embossed, stitched, coupled, or additively attached to the wicking material 100. For instance, the surface features 102 may attached to the wicking material 200 using, for instance, an adhesive. In some examples, the surface features 102 may be made of a hydrophilic material. In some instances, the surface features 102 and wicking material 100 may be of a same material. In other examples, the surface features 102 and wicking material 100 may be of different materials.

In some embodiments, for example FIG. 1, the surface features 102 form diamond-like patterns. The surface feature width 110 of each diamond-shaped surface feature 102 may be, for example, within a predetermined range of a width 170 of the wicking material 100. For example, the surface feature width 110 may be between 2% and 40% of the width 170 of the wicking material 100. In some examples, the surface feature width 110 may be between 10% to 25% of the width 170 of the wicking material 100. In some examples, the surface feature width 110 may be between 2% and 10% of the width 170 of the wicking material 100. In some examples, the surface feature width 110 may be between 20% and 30% of the width 170 of the wicking material 100. Similarly, a surface feature height 111 of each diamond-shaped surface feature 102 may be within a predetermined range of a height 171 of the wicking material 100. For example, the surface feature height 111 may be between 2% and 40% of the height 171 of the wicking material 100. In some examples, the surface feature height 111 may be between 10% and 25% of the height 171 of the wicking material 100. In some examples, the surface feature height 111 may be within a range, such as 0.5 centimeters (cm) to 15 cm. For instance, the surface feature height 111 may be from 4 cm to 10 cm.

In addition, the number of diamond patterned surface features 102 increases along a first portion 103 of the wicking material 100. For example, along the first portion 103 of the wicking material 100 a first diamond patterned surface feature 102A is followed by two diamond patterned surface features 102B, 102C, which are themselves followed by three diamond patterned surface features 102 and four diamond patterned surface features 102. Along a second portion 107 of the wicking material the surface features 102 form a symmetric pattern that includes four diamond patterned surface features 102 followed by three diamond patterned surface features 102.

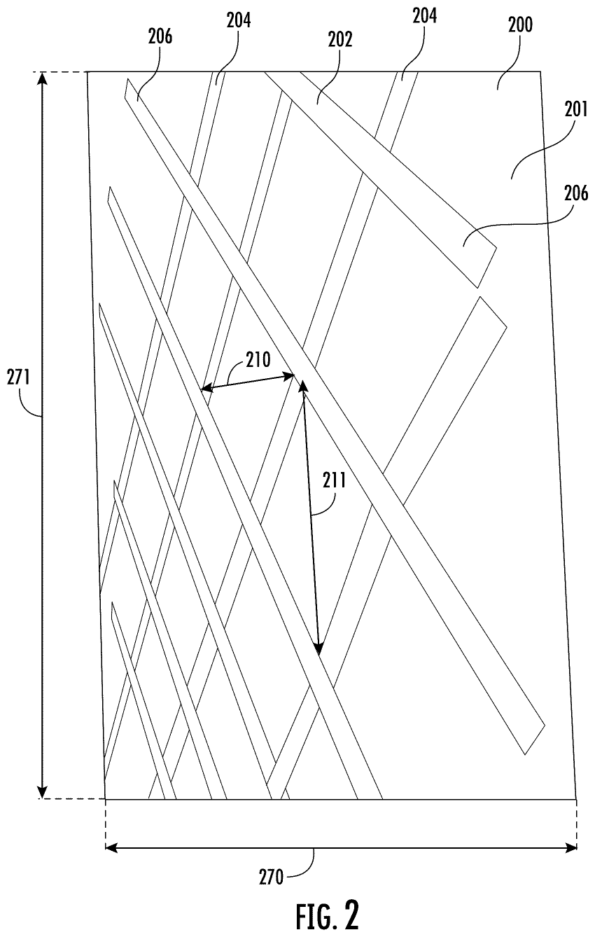

FIG. 2 illustrates an example of wicking material 200 that includes surface features 202 along a surface 201 of the wicking material. Further, the surface features 202 may be made out of a wicking material which may be the same, or different from, the wicking material 200. In this example, the surface features 202 and wicking material 200 form wick-on-wick diamond patterns. For instance, first strips 204 of the surface features 202 may extend in a first direction and may intersect second strips 206 of the surface features that extend in a second direction. The first strips 204 and second strips 206 may intersect at or near right angles, for example. In this example, the surface features 202 may form a symmetric pattern along most (e.g., at least 50%) or all of the surface 201 of the wicking material 200.

The surface feature width 210 of each diamond-shaped surface feature 202 may be, for example, within a predetermined range of a width 270 of the wicking material 100. For example, the surface feature width 210 may be between 2% and 40% of the width 270 of the wicking material 200. In some examples, the surface feature width 210 may be between 10% and 25% of the width 270 of the wicking material 200. Similarly, a surface feature height 211 of each diamond-shaped surface feature 202 may be within a predetermined range of a height 271 of the wicking material 100. For example, the surface feature height 211 may be between 2% and 10% of the height 271 of the wicking material 200. In some examples, the surface feature height 211 may be between 10% and 25% of the height 271 of the wicking material 200.

Although FIG. 1 and FIG. 2 illustrate surface features in diamond-like patterns, in other examples, surface features may be in other shapes or forms. For example, the surface features may be in the shape of hexagons, octagons, irregular polygons, herringbone, scallop shaped, or continual branching (e.g., similar to roots of a tree). In some examples, the surface features are fully connected (e.g., each surface feature is connected to at least another surface feature). In other examples, the surface features are not fully connected (e.g., each surface feature does not contact another surface feature).

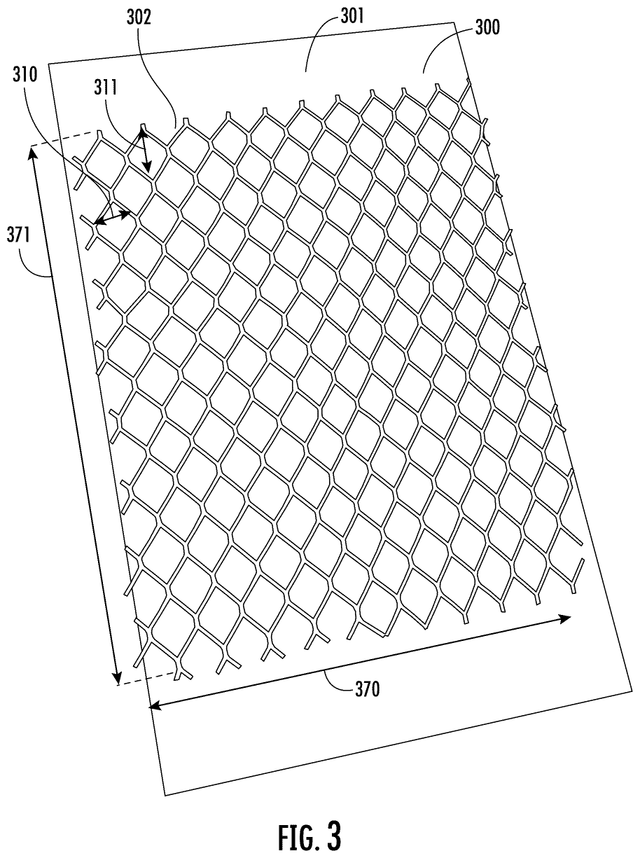

FIG. 3, for example, illustrates exemplary wicking material 300 that includes surface features 302 in a hexagon pattern along a surface 301 of the wicking material 300. The hexagon-shaped surface features 302 form a symmetric pattern throughout at least a portion of the surface 301. In some examples, the hexagon-shaped surfaces features 302 may be manufactured from any plastic, metal, or alloy material. Further, the hexagon-shaped surface features 302 may be attached to the wicking material 300 using, for instance, an adhesive, or may be stitched to the wicking material 300.

A surface feature width 310 of each hexagon shaped surface feature 302 may be, for example, within a predetermined range of a width 370 of the wicking material 300. For example, the surface feature width 310 may be between 2% and 25% of the width 370 of the wicking material 300. In some examples, the surface feature width 310 may be between 2% and 10%, or 10% and 25%, of the width 370 of the wicking material 300. Similarly, a surface feature height 311 of each surface feature 302 diamond pattern may be within a predetermined range of a height 371 of the wicking material 300. For example, the surface feature height 311 may be between 2% and 25% of the height 371 of the wicking material 300. In some examples, the surface feature height 311 may be between 10% and 20% of the height 371 of the wicking material 300.

FIG. 4A illustrates an exemplary plate assembly 400 that includes wicking material 402 adjacent a plate 410. The wicking material 402 may extend along a portion of the plate 410. For example, a width 421 of the wicking material 402 may be within a range of a width 423 of the plate 410. In some examples, the width 421 of the wicking material may be between 25% and 75% of the width 423 of the plate 410. In other examples, the width 421 of the wicking material may be between 50% and 100% of the width 423 of the plate 410. The plate 410 is configured to deliver a liquid desiccant 403 to the wicking material 402. The liquid desiccant 403 may flow in a generally downward direction through and along a surface 401 of the wicking material 402.

Further, the wicking material 402 includes a plurality of surface features 404 along its surface 401. As described herein, the plurality of surface features 404 may alter a flow of the liquid desiccant 403 along the surface 401 of the wicking material 402. For example, the liquid desiccant 403, as it flows downwardly along the surface 401 of the wicking material 402, may have a tendency to form rivulets, such as rivulet 411. When a rivulet encounters a surface feature 404, the surface feature 404 is adapted to disperse the rivulet so it spreads to other portions of the wicking material 402. As illustrated, for example, surface feature 404A may divert rivulet 411 to portions of the wicking material 402 as indicated by arrows 413, 415. As a result, the surface features 404 may provide more uniform flow over and wetting of the wicking material 402. Dispersing rivulets can have the benefit of providing more contact time between the liquid desiccant 403 and air flowing through the channel (e.g., conditioning channels 501 or 551).

In some examples, the plurality of surface features 404 may include cutouts of the wicking material 402. For example, a surface feature 404 may be defined by a cavity carved out of or pressed into (e.g., embossed) the surface 401 of the wicking material 402. In some examples, the plurality of surface features 404 may include protrusions that extend outward from the surface 401.

Further, in the example of FIG. 4A, the plurality of surface features 404 can form symmetric patterns along the surface 401 of the wicking material 402. In other examples, such as FIG. 4B, the plurality of surface features 404 may form asymmetric patterns along the surface 401 of the wicking material 402. In addition, as shown in FIG. 4A, the plurality of surface features 404 are uniformly distributed throughout the surface 401 of the wicking material 402.

FIG. 4B illustrates an exemplary plate assembly 450 that includes wicking material 452 adjacent a plate 460. The wicking material 452 includes a plurality of surface features 454 that can distribute a flow of the liquid desiccant 403 as it flows along a surface 451 of the wicking material 452. In this example, the density of surface features 454 decrease in a downward direction along the surface 451 of the wicking material 452. For example, a density of the plurality of surface features 454 generally decreases in the downward direction along the surface 451 of the wicking material 452. In some examples, the density of the plurality of surface features 454 may increase in the downward direction along the surface 451 of the wicking material 452. For example, the density of the plurality of surface features 454 may generally increase in the downward direction along the surface 451 of the wicking material 452.

FIG. 5A illustrates an exemplary plate assembly 500 that includes a first plate 502 and a second plate 504. The first plate 502 includes a first side 511 and a second side 513. The second side 513 is opposite the first side 511. Similarly, the second plate 504 includes a first side 521 and a second side 523, where the second side 523 is opposite the first side 521. The first side 511 of the first plate 502 and the first side 521 of the second plate 504 define a conditioning channel 501.

The first plate 502 includes wicking material 503 adjacent the first side 511. The wicking material 503 includes a plurality of surface features 507 along a surface 515. Similarly, the second plate 504 includes wicking material 505 adjacent the first side 521. The wicking material 505 includes a plurality of surface features 509 along a surface 517. In this example, the plurality of surface features 507 of the wicking material 503, and the plurality of surface features 509 of the wicking material 505, extend into the conditioning channel 501. As described herein, each of the plurality of features 507 and the plurality of surface features 509 may be stamped, molded, machined, embossed, stitched, coupled, or additively attached to the wicking materials 503, 505, respectively.

In this example, the plurality of surface features 509 are aligned along the surface 517 of the wicking material 505 such that they are laterally across portions of the wicking material 503 of the first plate 502 that do not include surface features 507. For example, as illustrated, surface feature 509A is positioned along surface 517 of wicking material 505 such that it is laterally across a portion 519 of wicking material 503 that is between surface features 507A and 507B (i.e., features 507 and features 509 are staggered). Similarly, the plurality of surface features 507 are aligned along the surface 515 of the wicking material 503 such that they are laterally across portions of the wicking material 505 of the second plate 504 that do not include surface features 509 (i.e., features 507 and features 509 are staggered). Among other advantages, this configuration allows the surface features 507, 509 to not result in the channel width being reduced below a certain critical bridging gap width (e.g., the minimum width to prevent at least some liquid desiccant from bridging the conditioning channel 501). For example, the surface features 507 are positioned to be at least a distance equivalent to the critical bridging gap width from the wicking material 505. Likewise, the surface features 509 are positioned to be at least a distance equivalent to the critical bridging gap width from the wicking material 503. Similarly, in some configurations, surface features are aligned along surfaces of wicking material positioned along sides of an exhaust channel (e.g., exhaust channel 650) such that they do not result in the exhaust channel width being reduced below a certain critical bridging gap width (e.g., the minimum width to prevent at least some coolant (e.g., water) from bridging the exhaust channel).

In some examples, the surface features 509 of the wicking material 505 of the second plate 504 are positioned a minimum distance 508 from the surface 515 of the wicking material 503 of the first plate 502. For instance, the minimum distance 508 may be from 1 millimeter (mm) to 12 mm, such as from 2 mm to 6 mm. Additionally or alternatively, in some instances the surface features 507 of the wicking material 503 of the first plate 502 are positioned a minimum distance 510 from the surface 517 of the wicking material 505 of the second plate 504.

FIG. 5B illustrates an exemplary plate assembly 550 that includes a first plate 522 and a second plate 524. The first plate 522 includes a first side 531 and a second side 533. The second side 533 is opposite the first side 531. Similarly, the second plate 524 includes a first side 541 and a second side 543, where the second side 543 is opposite the first side 541. The first side 531 of the first plate 522 and the first side 541 of the second plate 524 define a conditioning channel 551.

In this example, the first plate 522 includes wicking material 518 adjacent the first side 531, where the wicking material 518 includes a plurality of surface features 527 that are in the form of cutouts along a surface 545 of the wicking material 518. For instance, the plurality of surface features 527 may be formed by carving out portions of the wicking material 518 from the surface 545. For example, the surface features 527 may be in the shape of hexagons, octagons, irregular polygons, herringbone, scallop shaped, or continual branching (e.g., similar to roots of a tree). In some examples, the surface features 527 are fully connected. In other examples, the surface features 527 are not fully connected. Similarly, the second plate 524 includes wicking material 525 adjacent the first side 541. The wicking material 525 includes a plurality of surface features 529 that are in the form of cutouts along a surface 547 of the wicking material 525.

The plurality of surface features 527 are aligned along the wicking material 545 such that they are laterally across portions of the wicking material 525 of the second plate 524 that do not include surface features 529. For example, as illustrated, surface feature 527A of wicking material 518 is laterally across a portion 525A of wicking material 525 of second plate 524 that is between surface features 529A and 529B. Similarly, the plurality of surface features 529 of the second plate 524 are aligned along the wicking material 518 such that they are laterally across portions of the wicking material 518 of the first plate 522 that do not include surface features 527 (i.e., features 527 and features 529 are staggered).

In some examples, the surface features 527 of the wicking material 518 are positioned a minimum distance 538 from the surface 547 of the wicking material 525. For instance, the minimum distance 538 may be from 1 millimeter (mm) to 12 mm, such as from 2 mm to 6 mm. Additionally, or alternatively, in some instances, the surface features 529 of the wicking material 525 of the second plate 524 are positioned a minimum distance 540 from the surface 545 of the wicking material 518 of the first plate 531.

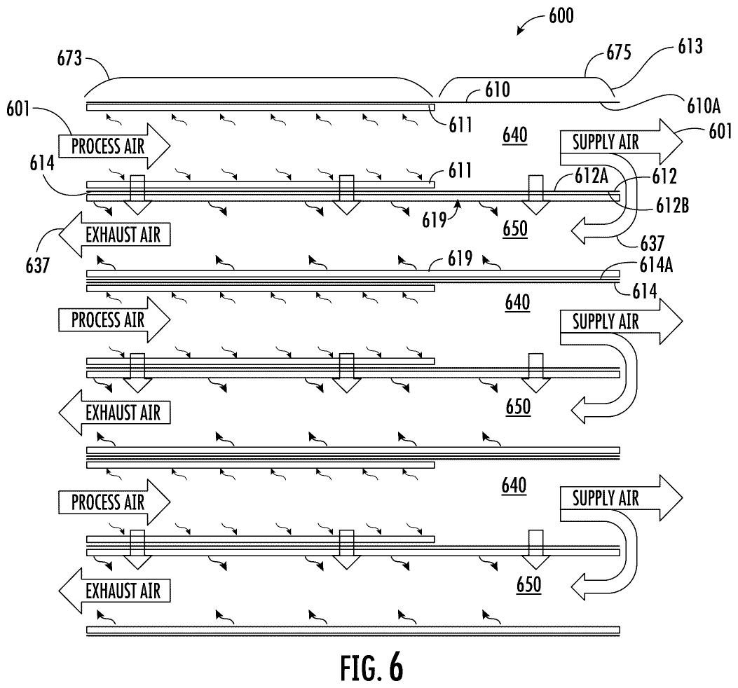

FIG. 6 illustrates a top view of a plate stack 600 that includes a plurality of conditioning channels 640 and a plurality of exhaust channels 650. A conditioning channel 640 and an adjacent exhaust channel 650 may form a channel pair. Although in this example three channel pairs are illustrated, in some examples, a plate stack may include any suitable number of channel pairs. Further, each channel pair includes a conditioning channel 640 that is defined by a first surface 610A of a first plate 610 and a first surface 612A of a second plate 612. Each channel pair also includes an exhaust channel 650 that is defined by a second surface 612B opposite the first surface 612A of the corresponding second plate 612 and a first surface 614A of a third plate 614.

A stream of process air 601 flows through the conditioning channels 640 to provide a stream of supply air 601 (e.g., to a building). Each conditioning channel 640 includes a dehumidifying section 673 and a cooling section 675. The dehumidifying section 673 includes wicking material 611, where the wicking material 611 includes a plurality of surface features as described herein. For example, the wicking material 611 may be any of wicking materials 100, 200, 300, 402, 452, 503, 505, 523, or 525.

The plate stack 600 is configured to deliver a conditioning fluid, such as liquid desiccant, from the first surface 610A of each first plate 610, and from the first surface 612A of the corresponding second plate 612, to their corresponding wicking material 611.

A conditioning fluid, such as a liquid desiccant, is provided along a portion of the first surface 610A of each first plate 610 and/or along a portion of the first surface 612A of the corresponding second plate 612. The conditioning fluid may flow within, and along a surface of, the wicking material 611. As described herein, the surface features of the wicking material 611 may divert the flow of the conditioning fluid along the surface of the wicking material.

As the stream of process air 601 flows through the conditioning channel 640, the conditioning fluid (e.g., liquid desiccant) absorbs moisture from the stream of mixed air to provide the supply air 601. Further, a portion of the stream of supply air 601 is provided back through each exhaust channel 650 to provide a stream of exhaust air 637.

In some examples, as the stream of exhaust air 637 flows through the exhaust channel 650, the stream of exhaust air 637 absorbs heat from working fluid 619 (e.g., water) provided on one or more of the second surface 612B of the second plate 612 and the first surface 614A of the third plate 614. For instance, heat may pass from the conditioning channel 640, through second plate 612, and be absorbed by the portion of the stream of supply air 601 flowing through the exhaust channel 650. Where a portion of the second plate 612 is in contact with the working fluid 619 on one side and the conditioning fluid on the other side, evaporation of the working fluid 619 can function to cool the conditioning fluid. Similarly, where a portion of the second plate 612 is in contact with the working fluid 619 on one side and the supply air 601 on the other side, evaporation of the working fluid 619 can function to cool the supply air 601. In the arrangement shown in FIG. 6, this results in cooling of dehumidified supply air 601, which may be more efficient than cooling humidified process air 601 entering the conditioning channel 640.

At least some of the embodiments described herein provide a plate assembly that includes a plate with a first side that defines a side of a conditioning channel, and a second side that defines a side of an exhaust channel. In addition, the plate assembly includes wicking material adjacent to the first side of the first plate. The wicking material has a surface with a plurality of surface features. The surface features may include cutouts into the surface of the wicking material, or additional material that extends into the conditioning channel. For instance, the additional material may be embossed, stamped, molded, machined, 3D printed, or otherwise additively attached to the wicking material. The plate is configured to deliver liquid desiccant to the wicking material. For instance, the plate may deliver liquid desiccant to a top portion of the wicking material. As the liquid desiccant flows along the surface of the wicking material in a downwardly direction, the surface features divert the flow of liquid desiccant. Among other advantages, the surface features may provide the liquid desiccant to unwetted, or less wet, areas of the wicking material, and may provide a more uniform wetting of the wicking material.

In some examples, a mass transfer apparatus includes alternating conditioning channels and exhaust channels defined by adjacent plates. For example, the mass transfer apparatus may include a stack having a plurality of plates, where the stack defines a plurality of channel pairs, and where each channel pair has one conditioning channel and one exhaust channel. The mass transfer apparatus includes wicking material adjacent the sides of the plates that define the conditioning channels. The wicking material includes surface features facing the conditioning channels. The mass transfer apparatus is configured to provide liquid desiccant to the wicking material on either side of the conditioning channels. The surface features provide topography to the surfaces of the wicking material, thereby diverting the liquid desiccant as it flows down the surfaces of the various wicking materials.

The various embodiments described above are provided by way of illustration only and should not be construed to limit the claims attached hereto. Those skilled in the art will readily recognize various modifications and changes that may be made without following the example embodiments and applications illustrated and described herein, and without departing from the spirit and scope of the following claims.

What is claimed is:

1. A plate assembly, comprising:
a first plate comprising:
a first side defining a side of a conditioning channel; and
a second side, opposite the first side, defining a side of an exhaust channel; and
wicking material adjacent the first side of the first plate, the wicking material comprising a surface comprising a plurality of surface features.

2. The plate assembly of claim 1, wherein the first plate is configured to provide liquid desiccant to the wicking material.

3. The plate assembly of claim 2, wherein the plurality of surface features alter a flow of the liquid desiccant along the surface of the wicking material.

4. The plate assembly of claim 1, wherein the plurality of surface features comprise cutouts in the surface of the wicking material.

5. The plate assembly of claim 1, wherein the plurality of surface features comprise embossed features.

6. The plate assembly of claim 5, wherein the embossed features comprise at least one feature that is stamped, molded, machined, 3D printed, or additively attached to the wicking material.

7. The plate assembly of claim 1, wherein the plurality of surface features are hydrophilic.

8. The plate assembly of claim 1, wherein the plurality of surface features comprise a second wicking material coupled to the wicking material and provides topography to the surface of the wicking material.

9. The plate assembly of claim 1, wherein the plurality of surface features comprise protrusions that extend into the conditioning channel.

10. The plate assembly of claim 1, wherein the plurality of surface features are configured to disperse or redirect surface flow of the liquid desiccant as they flow along the surface of the wicking material.

11. The plate assembly of claim 1, wherein the plurality of surface features are configured to disperse the rivulets to provide more uniform wetting of the wicking material.

12. The plate assembly of claim 1, wherein the plurality of surface features form symmetric patterns along the surface of the wicking material.

13. The plate assembly of claim 1, wherein the plurality of surface features form asymmetric patterns along the surface of the wicking material.

14. The plate assembly of claim 1, wherein the plurality of surface features are uniformly distributed throughout a surface of the wicking material.

15. The plate assembly of claim 1, wherein a density of the plurality of surface features decreases in a downward direction along the surface of the wicking material.

16. The plate assembly of claim 1, wherein a density of the plurality of surface features increases in a downward direction along the surface of the wicking material.

17. The plate assembly of claim 1, wherein the surface comprising the plurality of surface features faces the conditioning channel.

18. The plate assembly of claim 1 comprising:
a second plate defining another side of the conditioning channel; and
additional wicking material adjacent the second plate, the additional wicking material comprising a surface comprising additional surface features.

19. The plate assembly of claim 18, wherein the additional surface features are staggered with respect to the plurality of surface features across the conditioning channel.

20. The plate assembly of claim 18, wherein a first pattern of the plurality of surface features is different from a second pattern of the additional surface features.
